(19) United States
(12) Patent Application Publication
(10) Pub. No.: US 2022/0126914 A1
(43) Pub. Date: Apr. 28, 2022

(54) Method and System for Controlling In-Situ Rotation Mode of Four-Wheel Independent Steering Type Vehicle

(71) Applicants: Hyundai Motor Company, Seoul (KR); Kia Corporation, Seoul (KR)

(72) Inventors: Jeong Hwan Park, Seoul (KR); Do Hyun Kong, Gwangmyeong-si (KR)

(21) Appl. No.: 17/336,604

(22) Filed: Jun. 2, 2021

(30) Foreign Application Priority Data
Oct. 27, 2020 (KR) 10-2020-0140561

(51) Int. Cl. B62D 7/15; B60K 35/00

(52) U.S. Cl. CPC B62D 7/15; B60K 2370/167; B60K 35/00

(57) ABSTRACT

A control method of an in-situ rotation mode of a four-wheel independent steering type vehicle includes, when the in-situ rotation mode of the vehicle is executed, a wheel rotation operation for rotating, by a controller, a wheel according to the in-situ rotation mode, when a steering wheel is steered, a target rotation angle calculation operation for calculating, by the controller, a target rotation angle of the vehicle based on a steering angle of the steering wheel, and when a step-in signal of an accelerator pedal is applied, a rotation control operation for controlling, by the controller, the vehicle to be rotated in-situ by as much as the target rotation angle.

### CROSS-REFERENCE TO RELATED APPLICATIONS

This application claims the benefit of Korean Patent Application No. 10-2020-0140561, filed on Oct. 27, 2020, which application is hereby incorporated herein by reference.

### TECHNICAL FIELD

The present disclosure relates to a method and a system for controlling an in-situ rotation mode of a four-wheel independent steering type vehicle.

### BACKGROUND

Since conventional vehicles steer wheels only in two modes (driving straight and left/right turning), the conventional vehicles can be intuitively driven using only a small number of operating systems. On the other hand, four-wheel independent steering (4WS) systems can independently control each wheel to implement various vehicle behaviors.

To describe with reference to FIGS. 1A and 1B, in a general front wheel driving mode and a general rear wheel driving mode, wheels are rotated as much as a steering wheel is rotated, and acceleration is achieved as much as an accelerator pedal is stepped on so that the vehicle can rotate while traveling forward. In this case, since whether to steer rear-wheels in reverse phase with respect to front wheels can be determined on the basis of a vehicle speed or a steering angle, it may help to reduce a turning radius during a U-turn.

In addition, in a diagonal movement mode as shown in FIG. 1C, the rear wheels are controlled in phase with respect to the front wheels so that yawing does not occur in the vehicle. This has an advantage when the vehicle changes a lane or passes a forward vehicle.

In addition, in a parallel movement mode as shown in FIG. 1D, a 90° rotation of each of the front and rear wheels is possible so that it is advantageous for parallel parking.

In addition, in an in-situ rotation mode as shown in FIG. 1E, a 450 rotation of each of the front and rear wheels is possible so that the vehicle can perform a U-turn in an alleyway.

Meanwhile, the in-situ rotation mode is one of the most unusual driving modes of the 4WS system together with the parallel movement mode. Since the in-situ rotation mode is an unusual driving mode, the in-situ rotation mode can be differentiated from the existing vehicles and appeal to customers but has the following problems.

First, the in-situ rotation mode is a mode in which only the yawing behavior of the vehicle occurs, and the yawing behavior of the vehicle is not familiar to a driver so that the driver may feel discomfort of such a vehicle behavior.

Second, in the in-situ rotation mode, a vehicle movement direction does not coincide with a direction of a field of view of a driver. Thus, since the driver should turn the whole body to secure a field of view and drive in a state of anxiety about when to stop a turning, there are a problem of difficulty in a driving operation and a problem of an accident risk.

The foregoing is intended merely to aid in the understanding of the background of the present disclosure, and is not intended to mean that the present disclosure falls within the purview of the related art that is already known to those skilled in the art.

### SUMMARY

The present disclosure relates to a method and a system for controlling an in-situ rotation mode of a four-wheel independent steering type vehicle. Particular embodiments relate to a method and a system for controlling an in-situ rotation mode of a four-wheel independent steering type vehicle, which allow an in-situ rotation behavior of the vehicle to be operated easily and simply to reduce driving anxiety and an accident risk.

Accordingly, embodiments of the present disclosure have been made keeping in mind problems occurring in the related art, and embodiments of the present disclosure provide a method and a system for controlling an in-situ rotation mode of a four-wheel independent steering type vehicle, which allow an in-situ rotation behavior of the vehicle to be operated easily and simply to reduce driving anxiety and an accident risk.

According to one embodiment, there is provided a control method including when an in-situ rotation mode of a vehicle is executed, a wheel rotation operation for steering and rotating, by a controller, a wheel according to the in-situ rotation mode, when a steering wheel is steered, a target rotation angle calculation operation for calculating, by the controller, a target rotation angle of the vehicle on the basis of a steering angle of the steering wheel, and when a step-in signal of an accelerator pedal is applied, a rotation control operation for controlling, by the controller, the vehicle to be rotated in-situ by as much as the target rotation angle.

In the target rotation angle calculation operation, the target rotation angle may be divided for each step according to a steering angle range of the steering wheel, and the target rotation angle may be set for each step.

The steering angle range may be set by continuously connecting predetermined angle ranges.

The target rotation angle calculation operation may be performed by an operation of a separately provided mechanism.

In the target rotation angle calculation operation, a separate step rotation mode button may be provided on a side surface of a gear shift lever, and the target rotation angle may be calculated when the step rotation mode button is operated.

In the target rotation angle calculation operation, when a specific button among gear shift buttons is pressed a predetermined number of times or more or for a predetermined period of time or more, the target rotation angle may be calculated.

In the target rotation angle calculation operation, the target rotation angle may be continuously changed and set to correspond to the steering angle of the steering wheel.

In the rotation control operation, when the vehicle is rotated in-situ, the steering wheel may be rotated in a direction opposite to a rotation direction of the vehicle by as much as an angle at which the vehicle is rotated.

In the rotation control operation, at the same time as the vehicle is rotated, the steering wheel may be rotated according to the rotation angle of the vehicle in the direction opposite to the rotation direction of the vehicle, and when the rotation of the vehicle is terminated, the steering wheel may be restored and rotated by as much as the angle at which the vehicle is rotated in the direction opposite to the rotation direction of the vehicle to allow a termination point of time of an in-situ rotation to be recognized.

In the rotation control operation, when the vehicle is rotated in-situ, the steering wheel may be rotated in a direction opposite to a rotation direction of the vehicle by as much as an angle at which a driver steers the steering wheel.

In the rotation control operation, at the same time as the vehicle is rotated, for the in-situ rotation of the vehicle, the steering wheel may be rotated in the direction opposite to the rotation direction of the vehicle according to the steering angle of the steering wheel steered by the driver, and when the rotation of the vehicle is terminated, the steering wheel may be restored and rotated by as much as the angle at which a driver steers the steering wheel in the direction opposite to the rotation direction of the vehicle to allow a termination point of time of an in-situ rotation to be recognized.

In the rotation control operation, during an in-situ rotation of the vehicle, when the steering wheel is additionally steered in a rotation direction of the vehicle, the vehicle may further be rotated by as much as an additional steering angle of the steering wheel.

In the rotation control operation, a rotation angle of the vehicle may be guided through a notification part.

The notification part may display the rotation angle of the vehicle on a cluster or guide the rotation angle of the vehicle through voice.

The notification part may temporarily provide a different operation feeling to the steering wheel at every predetermined rotation angle during the in-situ rotation of the vehicle.

In the rotation control operation, a rotation speed of the vehicle may be determined according to a step-in amount of the accelerator pedal to rotate the vehicle.

In the rotation control operation, rotational acceleration may be gradually increased within a range of a step-in amount of the accelerator pedal at an initial stage of the rotation of the vehicle.

In the rotation control operation, the rotational acceleration may be gradually decreased before the target rotation angle is reached at an end stage of the rotation of the vehicle.

In the rotation control operation, when the brake pedal is stepped in while the vehicle is rotated, a rotation speed of the vehicle may be reduced.

According to another embodiment, there is provided a system for controlling an in-situ rotation mode of a four-wheel independent steering type vehicle, which includes a controller configured to steer and rotate a steering wheel when an in-situ rotation mode of a vehicle is executed, calculate a target rotation angle of the vehicle on the basis of a steering angle of the steering wheel when the steering wheel is steered, and control the vehicle to be rotated in-situ by as much as the target rotation angle when a step-in signal of an accelerator pedal is applied.

### BRIEF DESCRIPTION OF THE DRAWINGS

The above and other objects, features and other advantages of the present disclosure will be more clearly understood from the following detailed description when taken in conjunction with the accompanying drawings, in which:

FIGS. 1A to 1F are diagrams for describing a steering rotation of a wheel and a vehicle behavior for each driving mode of a four-wheel independent steering type vehicle;

FIG. 2 is a block diagram illustrating a control system of a four-wheel independent steering type vehicle according to embodiments of the present disclosure;

FIG. 3 is a diagram for describing an operation in which an in-situ rotation of a vehicle is divided and set in units of 30° and rotated according to embodiments of the present disclosure;

FIG. 4 is a diagram for describing an operation in which an in-situ rotation of the vehicle is divided and set in units of 45° and rotated according to embodiments of the present disclosure;

FIGS. 5 and 6 are schematic exemplary diagrams illustrating a mode switching mechanism applied to the four-wheel independent steering type vehicle according to embodiments of the present disclosure;

FIG. 7 is a step-by-step diagram illustrating rotation behaviors of a steering wheel and a vehicle during an in-situ rotation process of a vehicle according to embodiments of the present disclosure;

FIG. 8 is a diagram for describing an operation of warning an in-situ rotation angle through an operation feeling change in embodiments of the present disclosure; and

FIG. 9 is a flowchart illustrating an overall process of controlling an in-situ rotation mode of the four-wheel independent steering type vehicle according to embodiments of the present disclosure.

### DETAILED DESCRIPTION OF ILLUSTRATIVE EMBODIMENTS

Exemplary embodiments of the present disclosure will be described in detail below with reference to the accompanying drawings.

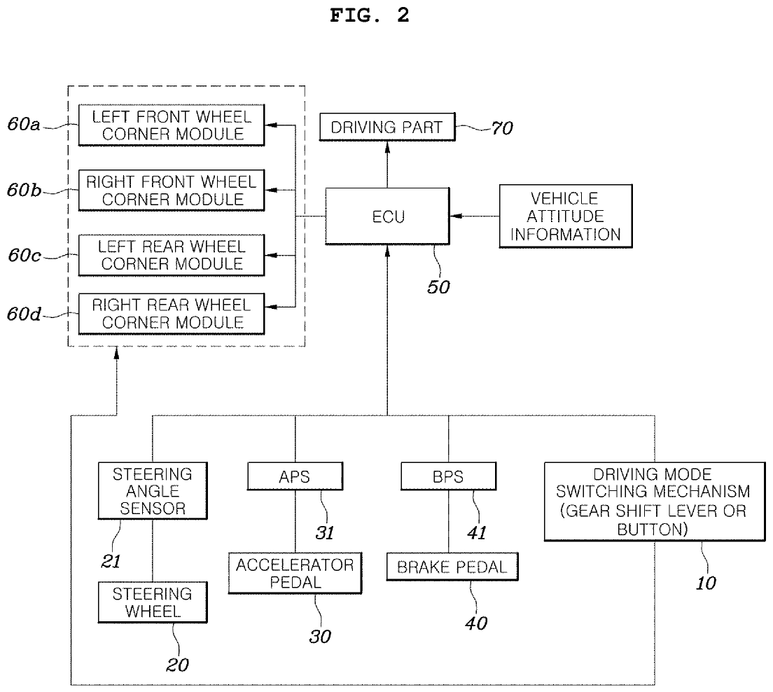

FIG. 2 is a block diagram illustrating a control system of a driving mode switching of a four-wheel independent steering type vehicle according to embodiments of the present disclosure.

Referring to the drawing, a four-wheel steering system which is applicable to the present disclosure includes a driving mode switching mechanism 10, a steering wheel 20, an accelerator pedal 30, a brake pedal 40, a controller 50 (electronic control unit or (ECU), corner modules 60a, 60b, 60c, and 60d for performing independent steering in wheels, and a driving part 70.

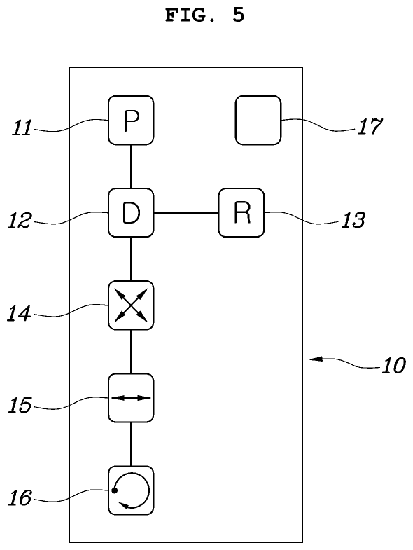

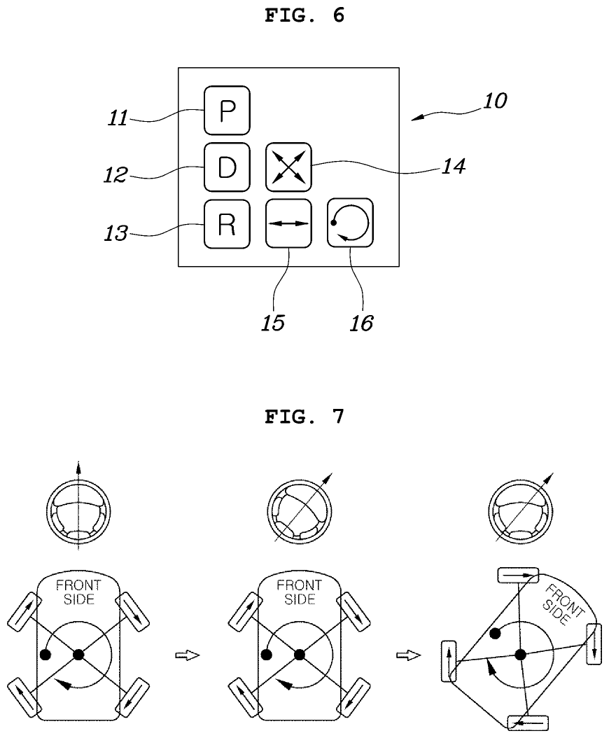

Specifically, the driving mode switching mechanism 10 may be implemented through a gear shift lever which is operated to be moved within a gear shift gate as shown in FIG. 5 or implemented through gear shift buttons as shown in FIG. 6.

For example, in the case of a gear shift lever type mechanism of FIG. 5, a gear shift gate is formed along a movement path of the gear shift lever, and a general driving mode including a P-stage (parking stage) mode 11, a D-stage (driving stage) mode 12, and a R-stage (reverse stage) mode 13, and a special driving mode including a diagonal driving mode 14, a parallel movement mode 15, and an in-situ rotation mode 16 are disposed along the movement path of the gear shift lever.

In addition, in the case of the gear shift button type mechanism of FIG. 6, each of the general driving mode and the special driving mode may be disposed in the form of a button.

In addition, referring to FIG. 2, since a steering angle sensor 21 is connected to the steering wheel 20, a steering angle is detected through the steering angle sensor 21 and transmitted to the controller 50. For reference, a steering reaction force mechanism which generates a steering reaction force of the steering wheel 20 may be optionally added.

The accelerator pedal 30 is capable of operating a throttle valve, a step-in signal of the accelerator pedal 30 is detected through an accelerator position sensor (APS) 31, and the detected step-in signal is transmitted to the controller 50.

The brake pedal 40 is connected to a brake mechanism and is capable of operating the brake mechanism. A step-in signal of the brake pedal 40 is also detected through a brake pedal stroke sensor (BPS) 41, and the detected step-in signal is transmitted to the controller 50.

The existing corner modules may be employed as the corner modules 60a, 60b, 60c, and 60d. However, in order to maximize usability of four-wheel independent steering operations such as parallel parking and an in-situ rotation, it is appropriate to employ large steering angle corner modules 60a, 60b, 60c, and 60d, each of which is steered up to 90 degrees.

Each of the large steering angle corner modules 60a, 60b, 60c, and 60d includes a suspension system capable of sufficiently striding a gap with a wheel, a high bending angle drive shaft or an in-wheel system, and a steering actuator for providing an operating force to independently steer the large steering angle corner modules 60a, 60b, 60c, and 60d.

In particular, the controller 50 according to embodiments of the present disclosure rotates a wheel according to the in-situ rotation mode 16 when the in-situ rotation mode 16 of a vehicle is executed, calculates a target rotation angle of the vehicle on the basis of a steering angle of the steering wheel 20 when the steering wheel 20 is steered, and controls the vehicle to be rotated in-situ by as much as the target rotation angle when a step-in signal of the accelerator pedal 30 is applied.

For reference, the controller 50 according to an exemplary embodiment of the present disclosure may be an ECU.

In addition, the controller 50 may be implemented through an algorithm configured to control operations of various components of the vehicle, a non-volatile memory (not shown) configured to store data relating to software commands to reproduce the algorithm, or a processor (not shown) configured to perform operations, which will be described below, using data stored in a corresponding memory. Here, the memory and the processor may be implemented as separate chips. Alternatively, the memory and the processor may be implemented as a single chip in which the memory and the processor are integrated. The processor may be in the form of one or more processors.

Meanwhile, in embodiments of the present disclosure, a control method of an in-situ rotation mode of a four-wheel independent steering type vehicle using the controller 50 may broadly include a wheel rotation operation, a target rotation angle calculation operation, and a rotation control operation.

First, in the wheel rotation operation, when the in-situ rotation mode of the vehicle is executed, the controller 50 steers and rotates wheels according to the in-situ rotation mode.

For example, when a driver selects the in-situ rotation mode through the driving mode switching mechanism 10, the in-situ rotation mode is executed, and when the in-situ rotation mode is executed, the controller 50 steers and rotates front and rear wheels using the corner modules 60a, 60b, 60c, and 60d to suit to an in-situ rotation.

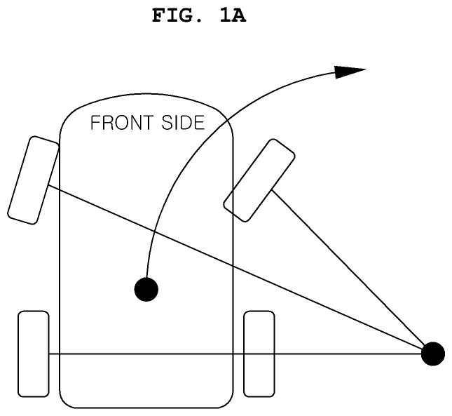

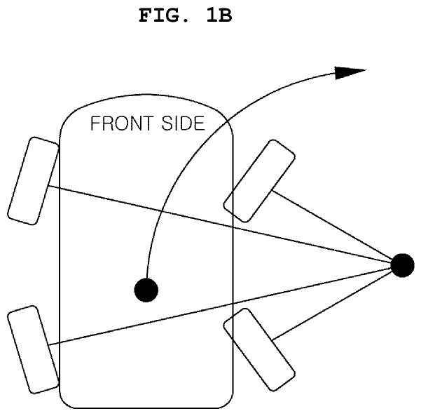

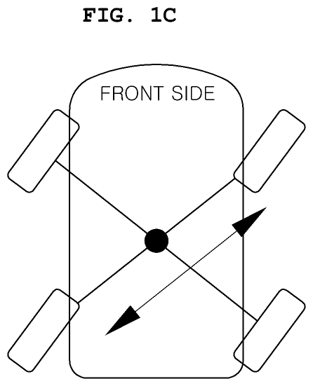

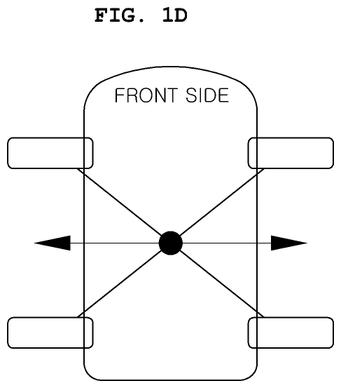

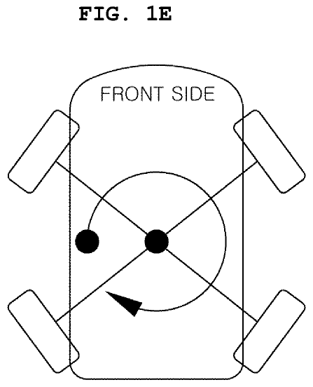

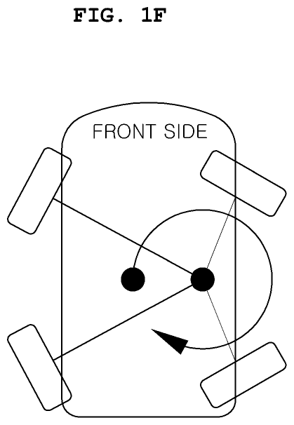

In this case, as shown in FIG. 1E, it is preferable to steer and rotate a left front wheel and a right rear wheel at an angle of 45° to a right side and to steer and rotate a right front wheel and a left rear wheel at an angle of 45° to a left side. However, the front and rear wheels may be steered and rotated in the form of FIG. 1F, and the rotated angles of the front and rear wheels may be steered in various forms allowing the in-situ rotation.

In the target rotation angle calculation operation, when the steering wheel 20 is steered, the controller 50 calculates the target rotation angle of the vehicle on the basis of a steering angle of the steering wheel 20.

That is, in a state in which the in-situ rotation mode is executed, when the driver steers the steering wheel 20 in a direction of a desired in-situ rotation, a target angle at which the vehicle is rotated in-situ is calculated on the basis of the steering angle which is detected through the steering angle sensor 21.

In the rotation control operation, when the step-in signal of the accelerator pedal 30 is applied, the controller 50 may control the vehicle to be rotated in-situ by as much as the target rotation angle.

That is, when the driver steps on the accelerator pedal 30 after the target rotation angle is set, a driving force is applied to a driving wheel to perform the in-situ rotation of the vehicle.

As described above, according to embodiments of the present disclosure, the target rotation angle is set by as much as a steering amount by which the driver operates the steering wheel 20, and the vehicle is rotated in-situ by as much as the set target rotation angle so that the driver easily and conveniently operates an in-situ rotation function of the vehicle to reduce driving anxiety and an accident risk.

Meanwhile, the target rotation angle calculation operation of embodiments of the present disclosure may be divided for each step according to the steering angle range of the steering wheel 20, and the target rotation angle may be set for each step.

That is, as an exemplary embodiment for calculating the target rotation angle, a rotation angle of the vehicle may be gradually recognized according to the steering amount by which the driver rotates the steering wheel 20 to set the target rotation angle.

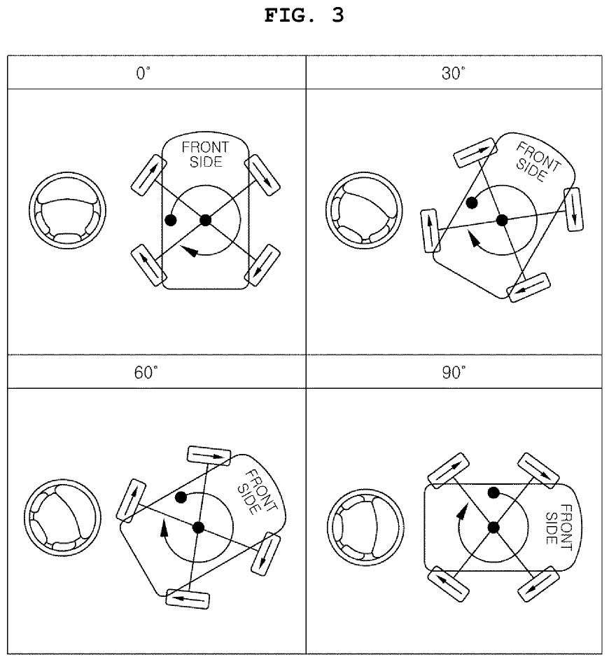

For example, FIG. 3 is a diagram for describing an operation in which the in-situ rotation of the vehicle is divided and set in units of 30° and the vehicle is rotated according to an embodiment of the present disclosure that illustrates an example in which a rotation angle of 90° is divided into and set to three steps in units of 30°.

Thus, when the driver rotates the steering wheel 20 at an angle in the range of 30° to 60°, the target rotation angle is set to 30° so that the vehicle may be rotated in-situ only at an angle of 30°.

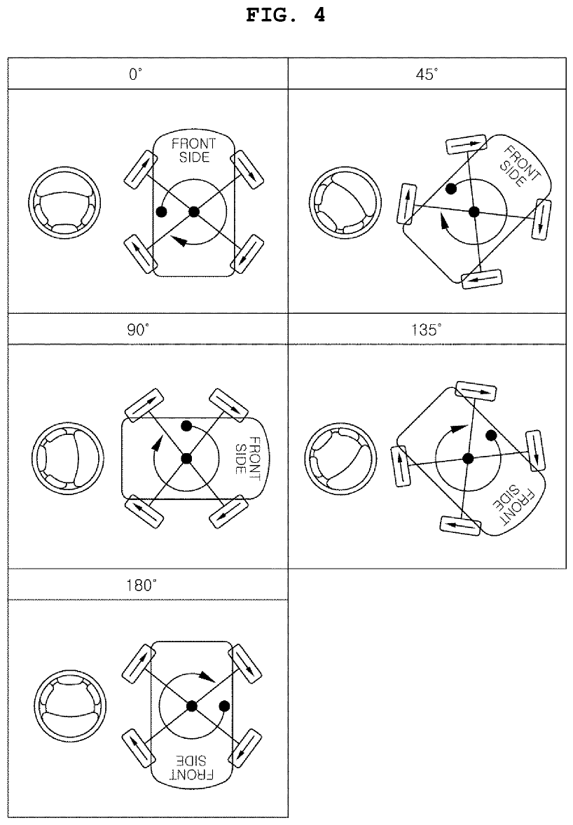

As another example, FIG. 4 is a diagram for describing an operation in which the in-situ rotation of the vehicle is divided and set in units of 45° and the vehicle is rotated according to an embodiment of the present disclosure that illustrates an example in which a rotation angle of 180° is divided into and set to four steps in units of 45°.

Thus, when the driver rotates the steering wheel 20 at an angle in the range of 45° to 90°, the target rotation angle is set to 45° so that the vehicle may be rotated in-situ only at an angle of 45°.

As described above, according to embodiments of the present disclosure, the steering angle range may be set by continuously connecting a predetermined angle range.

That is, the steering angle range for each step may be set in units of an angle of 30° as shown in FIG. 3 or set in units of an angle of 45° as shown in FIG. 4.

The rotation angles and the step illustrated in FIGS. 3 and 4 are merely examples for gradually setting the target rotation angle so that the rotation angles and the steps may be varied in various forms.

Therefore, it is possible to accurately control the rotation angle of the vehicle by rotating the vehicle by as much as a preset angle without considering a timing at which the driver would stop the vehicle. Therefore, an operation mistake of the steering wheel 20 due to dizziness during the rotation is prevented so that an accident risk may be reduced.

However, in the above described method of setting a target rotation angle, an in-situ rotation angle desired by the driver may not be accurately reflected to the rotation angle of the vehicle.

Thus, according to embodiments of the present disclosure, the calculating of the target rotation angle for each step may be configured to be operated by a separate operation.

For example, in the case of the gear shift lever type mechanism, a step rotation mode button 17 is separately provided on a side surface of an upper end of the gear shift lever so that, when the driver operates the step rotation mode button 17, the target rotation angle may be calculated for each step.

As another example, in the case of the gear shift button type mechanism, when the in-situ rotation mode button is continuously pressed two or more times or is pressed for a predetermined time or longer, the target rotation angle may be calculated for each step.

For example, in the case of a concept in which the vehicle is rotated in four steps by as much as an angle of 30°, even when the driver tries to rotate the vehicle by as much as an angle of 100° by rotating the steering wheel 20, the target rotation angle is 90° so that the vehicle is rotated by as much as only an angle of 90°.

Therefore, since the target rotation angle is calculated for each step only when the step rotation mode button 17 is operated, even though an intent of the driver is not accurately reflected, convenience of the in-situ rotation function of the vehicle may be improved.

In addition, as another example of the target rotation angle calculation operation, the target rotation angle may be set to be continuously varied in response to the steering angle of the steering wheel 20.

That is, when the steering wheel 20 is rotated at an angle of 100°, the target rotation angle is also set to 100° so that the vehicle is rotated in-situ by as much as the angle of 100°.

Therefore, it is possible to accurately reflect the intent of the driver to rotate the vehicle in-situ.

Meanwhile, FIG. 7 is a step-by-step diagram illustrating rotation behaviors of the steering wheel 20 and the vehicle during the in-situ rotation process of the vehicle according to embodiments of the present disclosure.

Referring to the drawing, in the rotation control operation, when the vehicle is rotated in-situ, the steering wheel 20 may be rotated by as much as an angle at which the vehicle is rotated in a direction opposite to the rotation direction of the vehicle.

Specifically, at the same time as the vehicle is rotated, the steering wheel 20 may be rotated according to the angle at which the vehicle is rotated in the direction opposite to the rotation direction of the vehicle, and when the rotation of the vehicle is terminated, the steering wheel 20 may be restored and rotated by as much as the angle at which the vehicle is rotated in the direction opposite to the rotation direction of the vehicle so that a termination point of time of the in-situ rotation may be recognized.

That is, in a state in which the in-situ rotation mode of the vehicle is executed, when the driver rotates the steering wheel 20 in a clockwise direction, the vehicle is rotated in-situ by as much as the target rotation angle in the clockwise direction.

Thus, at the same time as the in-situ rotation of the vehicle, the steering wheel 20 is restored and rotated by as much as the angle at which the vehicle is rotated in a counterclockwise direction opposite to the rotation direction of the vehicle so that in a state in which the rotation of the vehicle is completed by as much as the target rotation angle, an absolute angle of the steering wheel 20 maintains a state before the rotation of the vehicle.

Thus, since the steering wheel 20 is restored and rotated by as much as the rotation angle of the vehicle, a steering direction before the rotation of the vehicle may be maintained and a point of time at which the in-situ rotation of the vehicle is terminated is notified to the driver. Therefore, the driver easily recognizes the point of time at which the in-situ rotation of the vehicle is terminated so that convenience of the in-situ rotation function is increased and an accident risk is reduced.

However, in the target rotation angle calculation operation according to embodiments of the present disclosure, when the target rotation angle is calculated for each step, an angle of the in-situ rotation of the vehicle may be smaller than the steering angle at which the driver steers the steering wheel 20 so that a restoring rotation of the steering wheel 20 may not be restored to a position of the steering wheel 20 immediately before the in-situ rotation of the vehicle.

Thus, according to embodiments of the present disclosure, for the in-situ rotation, the steering wheel 20 may be controlled to be restored and rotated to correspond to the steering angle of the steering wheel 20 steered by the driver.

To describe the above description with reference to FIG. 7, in the rotation control operation, when the vehicle is rotated in-situ, the steering wheel 20 may be rotated by as much as the steering angle at which the driver steers the steering wheel 20 in a direction opposite to the rotation direction of the vehicle.

Specifically, at the same time as the vehicle is rotated, for the in-situ rotation of the vehicle, the steering wheel 20 may be rotated according to the steering angle at which the driver steers the steering wheel 20 in the direction opposite to the rotation direction of the vehicle, and when the rotation of the vehicle is terminated, the steering wheel 20 may be restored and rotated by as much as the steering angle at which the driver steers the steering wheel 20 in the direction opposite to the rotation direction of the vehicle so that a termination point of time of the in-situ rotation may be recognized.

That is, in a state in which the in-situ rotation mode of the vehicle is executed, when the driver rotates the steering wheel 20 in a clockwise direction, the vehicle is rotated in-situ by as much as the target rotation angle in the clockwise direction.

Thus, at the same time as the in-situ rotation of the vehicle, the steering wheel 20 is restored and rotated by as much as the steering angle at which the driver steers the steering wheel 20 in the counterclockwise direction opposite to the rotation direction of the vehicle so that in a state in which the rotation of the vehicle is completed by as much as the target rotation angle, an absolute angle of the steering wheel 20 maintains a state before the rotation of the vehicle.

Thus, since the steering wheel 20 is restored and rotated by as much as the angle at which the driver steers and rotates the steering wheel 20, a steering direction before the rotation of the vehicle may be maintained and a point of time at which the in-situ rotation of the vehicle is terminated is notified to the driver. Therefore, the driver easily recognizes the point of time at which the in-situ rotation of the vehicle is terminated so that convenience of the in-situ rotation function is increased and an accident risk is reduced.

In addition, in the rotation control operation, during the in-situ rotation of the vehicle, when the steering wheel 20 is additionally steered in the rotation direction of the vehicle, the vehicle may be further rotated by as much as an additional steering angle of the steering wheel 20.

That is, while the driver rotates the steering wheel 20 in the clockwise direction and thus the vehicle is rotated in-situ in the clockwise direction, when the driver further rotates the steering wheel 20 in the clockwise direction which is the rotation direction of the vehicle, the vehicle is further rotated in the clockwise direction by as much as the rotation angle of the steering wheel 20 so that the driver may rotate the vehicle by as much as a desired rotation angle.

Meanwhile, in the rotation control operation of embodiments of the present disclosure, the rotation angle of the vehicle may be guided through a notification part.

For example, as an exemplary embodiment of the notification part, the rotation angle of the vehicle may be displayed on a cluster or may be guided by voice.

When the rotation angle of the vehicle is displayed on the cluster, smooth operation recommendations of the accelerator pedal 30 may be guided together with the angle at which the vehicle is rotated in-situ.

In addition, as another embodiment of the notification part, a warning sound may be provided at a predetermined rotation angle during the in-situ rotation of the vehicle.

For example, as show in FIG. 4, when the vehicle is rotated by as much as the angle of 30° for each step, the warning sound may be provided at every angle of 30°.

In addition, as still another embodiment of the notification part, a different operation feeling may be temporarily provided to the steering wheel 20 at a predetermined rotation angle during the in-situ rotation of the vehicle.

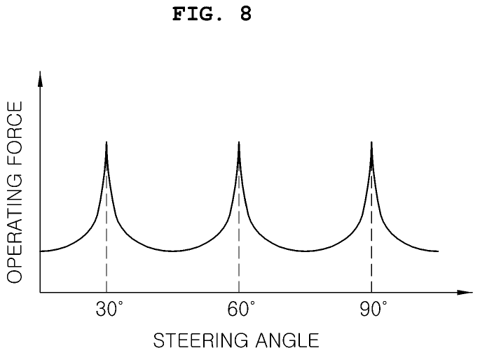

For example, FIG. 8 is a diagram for describing an operation of warning an in-situ rotation angle through an operation feeling change in embodiments of the present disclosure, and when the vehicle is rotated by as much as an angle of 30° for each step, a sense of holding to the steering wheel 20 may be provided at every angle of 30°.

Meanwhile, according to embodiments of the present disclosure, in the rotation control operation, a rotation speed of the vehicle is determined according to a step-in amount of the accelerator pedal 30 so that the vehicle may be rotated in-situ.

For example, in the case of a vehicle in which the driving part 70 is an engine, an opening degree amount of a throttle is adjusted by as much as an amount by which the driver steps on the accelerator pedal 30 to rotate the vehicle. In the case of a vehicle in which the driving part 70 is a motor, an output of the motor is determined by as much as an amount by which the driver steps on the accelerator pedal 30 to rotate the vehicle.

However, in the rotation control operation, rotational acceleration may be gradually increased within the range of the step-in amount of the accelerator pedal 30 at an initial stage of the rotation of the vehicle.

That is, when the driver excessively steps on the accelerator pedal 30 at an initial stage of the in-situ rotation, there are problems of dizziness due to a rapid turning of the vehicle, instability of a vehicle behavior, and reduction in lifetime of durability of related chassis parts.

Thus, yawing acceleration is gradually increased within the step-in amount range of the accelerator pedal 30 stepped on by the driver at the initial stage of the rotation of the vehicle so that smooth rotational acceleration is performed. Therefore, when the vehicle starts to be rotated, rapid acceleration is prevented so that smooth ride comfort may be provided and the vehicle may be safely rotated. Such rotational acceleration may be controlled by adjusting the opening degree amount of the throttle or adjusting an output of the motor.

In addition, in the rotation control operation, the rotational acceleration may be gradually reduced before reaching the target rotation angle at an end stage of the rotation of the vehicle.

That is, in order to allow smooth deceleration to be performed at the initial stage of the rotation of the vehicle as well as the end stage of the rotation of the vehicle, the yawing acceleration is gradually reduced so that rapid deceleration of the vehicle is prevented and thus smooth ride comfort may be provided.

In particular, when the rotational acceleration is controlled at the end stage of the rotation of the vehicle, braking is not performed according to the intent of the driver but is controlled to be stopped by itself at a position of the target rotation angle so that acceleration control may be performed more simply.

However, in embodiments of the present disclosure, when the driver steps on the brake pedal 40 while the vehicle is being rotated, the vehicle should be stopped.

To this end, in the rotation control operation, when the brake pedal 40 is stepped in while the vehicle is being rotated, the rotation speed of the vehicle is reduced.

That is, when the driver steps on the brake pedal 40 while the vehicle is being rotated, since the driver would stop the vehicle by allowing a danger inside or outside the vehicle to be recognized, when a signal of the brake pedal 40 is applied, the vehicle is decelerated.

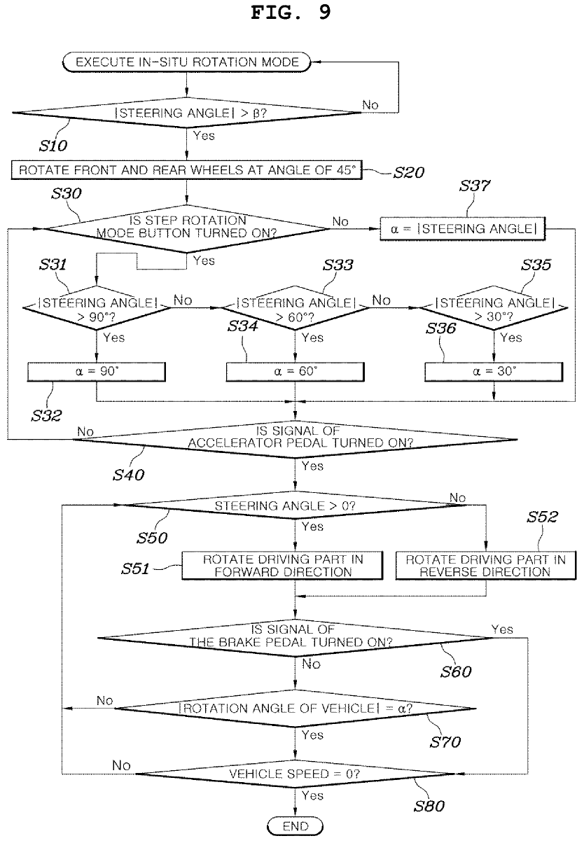

FIG. 9 is a flowchart illustrating an overall process of controlling an in-situ rotation mode of the four-wheel independent steering type vehicle according to embodiments of the present disclosure.

To describe with reference to the drawing, when the driver operates the gear shift lever or the gear shift button to select the in-situ rotation mode, whether an absolute value of the steering angle exceeds β (about two degrees) is determined (S10).

Thus, when the absolute value of the steering angle exceeds β, each of the front and rear wheels is steered and rotated by as much as an angle of 45° using the corner modules 60a, 60b, 60c, and 60d (S20).

Then, whether the step rotation mode button 17 is selected is determined (S30).

As the determination result in operation S30, when the step rotation mode button 17 is selected, a steering angle is detected and then a target rotation angle is set according to a steering angle range.

For example, when three step rotations are set in units of an angle of 30°, whether an absolute value of the steering angle exceeds 90° is determined (S31), and when the absolute value of the steering angle exceeds 90°, a target rotation angle α is set to 90° (S32).

Otherwise, when the absolute value of the steering angle does not exceed 90°, whether the absolute value of the steering angle exceeds 60° is determined (S33), and when the absolute value of the steering angle exceeds 60°, the target rotation angle α is set to 60° (S34).

In addition, when the absolute value of the steering angle does not exceed 60°, whether the absolute value of the steering angle exceeds 30° is determined (S35), and when the absolute value of the steering angle exceeds 30°, the target rotation angle α is set to 30° (S36).

However, as the determination result in operation S30, when the step rotation mode button 17 is not selected, the steering angle is detected and then the target rotation angle is set to correspond to the steering angle.

That is, when the absolute value of the steering angle is 100°, the target rotation angle α is set to 100° (S37).

Subsequently, whether a signal of the accelerator pedal 30 is turned on is determined (S40), and when the signal of the accelerator pedal 30 is turned on, whether the steering angle exceeds 0° is determined (S50), and then a rotation direction of the steering wheel 20 is determined.

For example, when the steering angle exceeds 0°, it is determined as a situation in which the steering wheel 20 is turned to a right side, and the driving part 70 for rotating the vehicle is rotated in a forward direction to rotate the vehicle in-situ in the clockwise direction (S51).

Otherwise, when the steering angle does not exceed 0°, it is determined as a situation in which the steering wheel 20 is turned to a left side, and the driving part 70 for rotating the vehicle is rotated in a reverse direction to rotate the vehicle in-situ in the counterclockwise direction (S52).

Subsequently, whether a signal of the brake pedal 40 is turned on is determined (S60), and when the signal of the brake pedal 40 is not turned on, it is determined whether an absolute value of the rotation angle of the vehicle coincides with a previously set target rotation angle to determine whether an in-situ rotation is achieved by as much as an intent of the driver (S70).

In addition, whether a vehicle speed of the in-situ rotation is zero is determined (S80), and when the vehicle speed of the in-situ rotation is zero, control is terminated.

In addition, as the determination result in operation S60, even when the signal of the brake pedal 40 is applied, the process proceeds to operation S80 to determine whether the vehicle speed of the in-situ rotation is zero, and when the vehicle speed of the in-situ rotation is zero, the control is terminated.

As described above, according to embodiments of the present disclosure, the target rotation angle is set by as much as the steering amount by which the driver operates the steering wheel 20, and the vehicle is rotated in-situ by as much as the set target rotation angle so that the rotation angle of the vehicle is accurately controlled, and the driver easily and conveniently operates the in-situ rotation function of the vehicle to reduce driving anxiety and prevent an incorrect operation of the steering wheel 20 due to dizziness during the rotation so that the accident risk may be reduced.

In accordance with embodiments of the present disclosure, a target rotation angle is set by as much as a steering amount by which a driver operates a steering wheel, and a vehicle is rotated in-situ by as much as the set target rotation angle so that a rotation angle of the vehicle can be accurately controlled, and the driver can easily and conveniently operate an in-situ rotation function of the vehicle to reduce driving anxiety and prevent an incorrect operation of the steering wheel due to dizziness during the rotation so that the accident risk can be reduced.

Meanwhile, although the present disclosure has been described in detail with respect to only the above described specific examples, it is obvious to those skilled in the art that various modifications and alterations are possible within the technical scope of the present disclosure, and it is natural that such modifications and alterations fall within the appended claims.

What is claimed is:

1. A control method of an in-situ rotation mode of a four-wheel independent steering type vehicle, the control method comprising:
performing a wheel rotation operation for rotating a wheel according to the in-situ rotation mode when the in-situ rotation mode of the vehicle is executed;
performing a target rotation angle calculation operation for calculating a target rotation angle of the vehicle based on a steering angle of a steering wheel when the steering wheel is steered; and
performing a rotation control operation for controlling the vehicle to be rotated in-situ by as much as the target rotation angle when a step-in signal of an accelerator pedal is applied.

2. The control method of claim 1, wherein, in the target rotation angle calculation operation, the target rotation angle is divided for each step according to a steering angle range of the steering wheel, and the target rotation angle is set for each step.

3. The control method of claim 2, wherein the steering angle range is set by continuously connecting predetermined angle ranges.

4. The control method of claim 2, wherein the target rotation angle calculation operation is performed by an operation of a separately provided mechanism.

5. The control method of claim 1, wherein, in the target rotation angle calculation operation, a separate step rotation mode button is provided on a side surface of a gear shift lever, and the target rotation angle is calculated when the step rotation mode button is operated.

6. The control method of claim 1, wherein, in the target rotation angle calculation operation, when a specific button among gear shift buttons is pressed a predetermined number of times or more or for a predetermined period of time or more, the target rotation angle is calculated.

7. The control method of claim 1, wherein, in the target rotation angle calculation operation, the target rotation angle is continuously changed and set to correspond to the steering angle of the steering wheel.

8. The control method of claim 1, wherein, in the rotation control operation, when the vehicle is rotated in-situ, the steering wheel is rotated in a direction opposite to a rotation direction of the vehicle by as much as an angle at which the vehicle is rotated.

9. The control method of claim 8, wherein, in the rotation control operation, at the same time as the vehicle is rotated, the steering wheel is rotated according to the rotation angle of the vehicle in the direction opposite to the rotation direction of the vehicle, and when the rotation of the vehicle is terminated, the steering wheel is restored and rotated by as much as the angle at which the vehicle is rotated in the direction opposite to the rotation direction of the vehicle to allow a termination point of time of an in-situ rotation to be recognized.

10. The control method of claim 1, wherein, in the rotation control operation, when the vehicle is rotated in-situ, the steering wheel is rotated in a direction opposite to a rotation direction of the vehicle by as much as an angle at which a driver steers the steering wheel.

11. The control method of claim 10, wherein, in the rotation control operation, at the same time as the vehicle is rotated, for the in-situ rotation of the vehicle, the steering wheel is rotated in the direction opposite to the rotation direction of the vehicle according to the steering angle steered of the steering wheel by the driver, and when the rotation of the vehicle is terminated, the steering wheel is restored and rotated by as much as the angle at which the driver steers the steering wheel in the direction opposite to the rotation direction of the vehicle to allow a termination point of time of an in-situ rotation to be recognized.

12. The control method of claim 1, wherein, in the rotation control operation, during an in-situ rotation of the vehicle, when the steering wheel is additionally steered in a rotation direction of the vehicle, the vehicle is further rotated by as much as an additional steering angle of the steering wheel.

13. The control method of claim 1, wherein, in the rotation control operation, a rotation speed of the vehicle is determined according to a step-in amount of the accelerator pedal to rotate the vehicle.

14. The control method of claim 1, wherein, in the rotation control operation, rotational acceleration is gradually increased within a range of a step-in amount of the accelerator pedal at an initial stage of the rotation of the vehicle.

15. The control method of claim 1, wherein, in the rotation control operation, rotational acceleration is gradually decreased before the target rotation angle is reached at an end stage of the rotation of the vehicle.

16. The control method of claim 1, wherein, in the rotation control operation, when a brake pedal is stepped in while the vehicle is rotated, a rotation speed of the vehicle is reduced.

17. A control method of an in-situ rotation mode of a four-wheel independent steering type vehicle, the control method comprising:
performing a wheel rotation operation for rotating a wheel according to the in-situ rotation mode when the in-situ rotation mode of the vehicle is executed;
performing a target rotation angle calculation operation for calculating a target rotation angle of the vehicle based on a steering angle of a steering wheel when the steering wheel is steered; and
performing a rotation control operation for controlling the vehicle to be rotated in-situ by as much as the target rotation angle when a step-in signal of an accelerator pedal is applied, wherein, in the rotation control operation, a rotation angle of the vehicle is guided through a notification part.

18. The control method of claim 17, wherein, the notification part displays the rotation angle of the vehicle on a cluster or guides the rotation angle of the vehicle through voice.

19. The control method of claim 17, wherein the notification part temporarily provides a different operation feeling to the steering wheel at every predetermined rotation angle during the in-situ rotation of the vehicle.

20. A vehicle comprising:
four wheels configured to operate in an in-situ rotation mode of a four-wheel independent steering type;
a steering wheel;
an accelerator pedal; and
a controller configured to steer and rotate the wheels according to the in-situ rotation mode when the in-situ rotation mode of a vehicle is executed, to calculate a target rotation angle of the vehicle based on a steering angle of the steering wheel when the steering wheel is steered, and to control the vehicle to be rotated in-situ by as much as the target rotation angle when a step-in signal of the accelerator pedal is applied.
